(19) United States
(12) Patent Application Publication
(10) Pub. No.: US 2025/0024284 A1
(43) Pub. Date: Jan. 16, 2025

(54) PERFORMANCE DATA COLLECTION IN A WIRELESS COMMUNICATIONS NETWORK

(71) Applicant: Lenovo (Singapore) Pte. Limited, Singapore (SG)

(72) Inventors: Emmanouil Pateromichelakis, Viersen (DE); Apostolis Salkintzis, Glika Nera (GR); Dimitrios Karampatsis, Ruislp (GB)

(73) Assignee: Lenovo (Singapore) Pte. Limited, Singapore (SG)

(21) Appl. No.: 18/715,825

(22) PCT Filed: Jan. 19, 2022
(86) PCT No.: PCT/EP2022/051073

§ 371 Date: Jun. 3, 2024

(30) Foreign Application Priority Data
Dec. 3, 2021 (GR) 20210100844

(51) Int. Cl. H04W 24/08; H04L 43/026; H04L 43/091; H04W 24/02

(52) U.S. Cl. CPC H04W 24/08; H04L 43/026; H04L 43/091; H04W 24/02

(57) ABSTRACT

There is provided a method in a wireless communications device, the method comprising: receiving a data collection requirement from a data collection coordination node, the data collection requirement defining a data collection event associated with application traffic between the wireless communications device and a node within the wireless communications network; detecting the occurrence of the data collection event; collecting data associated with application traffic between the wireless communications device and the node within the wireless communications network in respect of the data collection event; and sending the collected data to the data collection coordination node.

### FIELD

The subject matter disclosed herein relates generally to the field of implementing performance data collection in a wireless communications network. This document defines a method in a wireless communications device, a wireless communications device, a method in a data collection coordination node, and a data collection coordination node.

### BACKGROUND

In 3GPP SA2, data analytics services are provided by the Network Data Analytics Function (NWDAF), as defined in 3GPP TS 23.288 v 17.2.0. These data analytics services support network data analytics services in the 5G Core network. Such analytics can collect data from other Network Functions (NFs), or Application Functions (AF) or Operation Administration and Management (OAM). The collected data may be processed and can be exposed to third parties external to the network and/or AFs within the network. The processed data may comprise statistics and predictions related to slice Load level, observed Service experience, NF Load, Network Performance, User Equipment (UE) related analytics (such as mobility and/or communication), User data congestion, QoS sustainability, Data Network (DN) performance, etc.

### SUMMARY

A problem with existing performance data collection in wireless communications networks is that the sources from which data can be collected is limited.

Disclosed herein are procedures for performance data collection in a wireless communications network. Said procedures may be implemented by a wireless communications device or a data collection coordination node.

There is provided a method in a wireless communications device, the method comprising: receiving a data collection requirement from a data collection coordination node, the data collection requirement defining a data collection event associated with application traffic between the wireless communications device and a node within the wireless communications network; detecting the occurrence of the data collection event; collecting data associated with application traffic between the wireless communications device and the node within the wireless communications network in respect of the data collection event; and sending the collected data to the data collection coordination node.

The method may further comprise processing the collected data before sending the collected data to the data collection coordination node.

The data collection requirement may include at least one of: parameters to be collected for the data collection event; the resolution at which data is to be collected; an event identity identifying the data collection event; a time validity; a geographical area; an application service area; an application identity; and conditions for triggering the data collection event.

The data collection event may comprise at least one of: an end-to-end application performance related event for the application traffic associated with the wireless communication device; an end-to-end application performance related event for the application traffic associated with the wireless communication device and an application server, an end-to-end application performance related event for the application traffic associated with the wireless communication device and one or more further wireless communication devices; an application server performance related event, and a change of application traffic parameters.

Detecting the occurrence of the data collection event may comprise at least one of: initiation of a communication related to the application traffic; modification of one or more performance parameters related to the application traffic; a modification or termination of a communication related to the application traffic; and a deviation of a performance parameter from a desirable key performance indicator related to the application traffic.

There is further provided a wireless communications device comprising a receiver, a transmitter, and a processor. The receiver is arranged to receive a data collection requirement from a data collection coordination node, the data collection requirement defining a data collection event associated with application traffic between the wireless communications device and a node within the wireless communications network. The processor is arranged to detect the occurrence of the data collection event; and collect data associated with application traffic between the wireless communications device and a node within the wireless communications network in respect of the data collection event. The transmitter is arranged to send the collected data to the data collection coordination node.

There is further provided a method in a data collection coordination node, the method comprising: sending a first data collection requirement to a wireless communications device, the first data collection requirement defining a first data collection event associated with application traffic between the wireless communications device and a node within the wireless communications network; receiving collected data associated with application traffic between the wireless communications device and the node within the wireless communications network in respect of the data collection event.

The method may further comprise sending a second data collection requirement to an edge node, the second data collection requirement defining a second data collection event associated with the operation of the edge node; and receiving collected data associated with the second data collection requirement.

The first and/or second data collection event comprise at least one of: parameters to be collected; the resolution at which data is to be collected; an event identity; a time validity; a geographical area; an application service area; an application identity; and conditions for triggering the data collection event.

The first and/or second data collection event may comprise at least one of: an end-to-end application performance related event for the application traffic; an end-to-end application performance related event for the application traffic; an end-to-end application performance related event for the application traffic associated with the wireless communication device and one or more further wireless communication devices; an edge data network performance related event; a radio access network performance related event; a wireless communication device location event; an application server performance related event; and an application traffic parameters change event.

The method may further comprise storing the received collected data.

The method may further comprise generating a set of processed data based on the one or more received collected data. The method may further comprise storing the set of processed data. The method may further comprise transmitting the set of processed data to an external entity.

There is further provided a data collection coordination node comprising a transmitter and a receiver. The transmitter is arranged to send a first data collection requirement to a wireless communications device, the first data collection requirement defining a first data collection event associated with application traffic between the wireless communications device and a node within the wireless communications network. The receiver is arranged to receive collected data associated with application traffic between the wireless communications device and the node within the wireless communications network in respect of the data collection event.

### BRIEF DESCRIPTION OF THE DRAWINGS

In order to describe the manner in which advantages and features of the disclosure can be obtained, a description of the disclosure is rendered by reference to certain apparatus and methods which are illustrated in the appended drawings. Each of these drawings depict only certain aspects of the disclosure and are not therefore to be considered to be limiting of its scope. The drawings may have been simplified for clarity and are not necessarily drawn to scale.

Methods and apparatus for performance data collection in a wireless communications network will now be described, by way of example only, with reference to the accompanying drawings, in which:

FIG. 1 illustrates a known network data analytics in 5GC;

FIG. 2 illustrates a method in a wireless communications device;

FIG. 3 depicts a user equipment apparatus that may be used for implementing the methods described herein;

FIG. 4 illustrates a method in a data collection node;

FIG. 5 depicts further details of the network node that may be used for implementing the methods described herein;

FIG. 6 illustrates a proposed architecture for performance data collection in a wireless communications network;

FIG. 7 illustrates an example system wherein a round trip time metric is collected and reported;

FIG. 8 illustrates the arrangement described herein implemented by a system comprising entities within the 3GPP SA6 architecture;

FIG. 9 illustrates how these entities are mapped to the user-plane protocol stack from a UE to an edge node of the data network;

FIG. 10 is a signaling diagram illustrating data collection for server performance prediction; and

FIG. 11 is a signaling diagram illustrating data collection for application session performance prediction.

### DETAILED DESCRIPTION

As will be appreciated by one skilled in the art, aspects of this disclosure may be embodied as a system, apparatus, method, or program product. Accordingly, arrangements described herein may be implemented in an entirely hardware form, an entirely software form (including firmware, resident software, micro-code, etc.) or a form combining software and hardware aspects.

For example, the disclosed methods and apparatus may be implemented as a hardware circuit comprising custom very-large-scale integration (“VLSI”) circuits or gate arrays, off-the-shelf semiconductors such as logic chips, transistors, or other discrete components. The disclosed methods and apparatus may also be implemented in programmable hardware devices such as field programmable gate arrays, programmable array logic, programmable logic devices, or the like. As another example, the disclosed methods and apparatus may include one or more physical or logical blocks of executable code which may, for instance, be organized as an object, procedure, or function.

Furthermore, methods and apparatus may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain arrangements, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store, a program for use by or in connection with an instruction execution system, apparatus, or device.

Reference throughout this specification to an example of a particular method or apparatus, or similar language, means that a particular feature, structure, or characteristic described in connection with that example is included in at least one implementation of the method and apparatus described herein. Thus, reference to features of an example of a particular method or apparatus, or similar language, may, but do not necessarily, all refer to the same example, but mean “one or more but not all examples” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Furthermore, the described features, structures, or characteristics described herein may be combined in any suitable manner. In the following description, numerous specific details are provided, such as examples of programming, software modules, user selections, network transactions, database queries, database structures, hardware modules, hardware circuits, hardware chips, etc., to provide a thorough understanding of the disclosure. One skilled in the relevant art will recognize, however, that the disclosed methods and apparatus may be practiced without one or more of the specific details, or with other methods, components, materials, and so forth. In other instances, well-known structures, materials, or operations are not shown or described in detail to avoid obscuring aspects of the disclosure.

Aspects of the disclosed method and apparatus are described below with reference to schematic flowchart diagrams and/or schematic block diagrams of methods, apparatuses, systems, and program products. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams.

The code may also be loaded onto a computer, other programmable data processing apparatus, or other devices to cause a series of operational steps to be performed on the computer, other programmable apparatus, or other devices to produce a computer implemented process such that the code which execute on the computer or other programmable apparatus provide processes for implementing the functions/acts specified in the schematic flowchart diagrams and/or schematic block diagram.

The schematic flowchart diagrams and/or schematic block diagrams in the Figures illustrate the architecture, functionality, and operation of possible implementations of apparatuses, systems, methods, and program products. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

The description of elements in each figure may refer to elements of proceeding figures. Like numbers refer to like elements in all figures.

In 3GPP SA2, data analytics services are provided by the Network Data Analytics Function (NWDAF), as defined in 3GPP IS 23.288 v 17.2.0. These data analytics services support network data analytics services in the 5G Core network. Such analytics can collect data from other Network Functions (NFs), or Application Functions (AF) or Operation Administration and Management (OAM). The collected data may be processed and can be exposed to third parties external to the network and/or AFs within the network. The processed data may comprise statistics and predictions related to slice Load level, observed Service experience, NF Load, Network Performance, User Equipment (UE) related analytics (such as mobility and/or communication), User data congestion, QoS sustainability, Data Network (DN) performance, etc.

In vertical scenarios, further data analysis on top of the 5GS may be needed, to provide a useful output to an application specific layer for end-to-end application service, including the application server related and application session related stats/prediction. The stats/predictions may be supported/enhanced by collecting data from different domains based on the consumer needs. Such collection can be from the 5GS nodes such as Network Data Analytics Function (NWDAF) or Management Domain Analytics Service (MDAS) via northbound APIs, or from application specific layer/data network (DN). The collected data may be related to collecting HD maps, camera feeds, sensor data, data related to edge/cloud resources, data related to application server status (e.g., load of Edge Application Server/Application Server), or data from the UE side (e.g. UE routes/trajectories). This document describes how application data collection may be collected from these different sources, which include by way of example: vertical-specific server, application of the UE, EAS, third party server, Service Enabler Architecture Layer). This document further identifies how these data can be collected to allow for stats/predictions by the analytics enablement layer.

The use of network-layer and/or PDU layer measurement on the application sessions (for certain types and certain time of the day and/or area) may be beneficial for generating stats and/or predictions that could indicate the expected and/or predicted DN performance/failures or the expected/predicted application quality of service (QoS) possible degradation or sustainability.

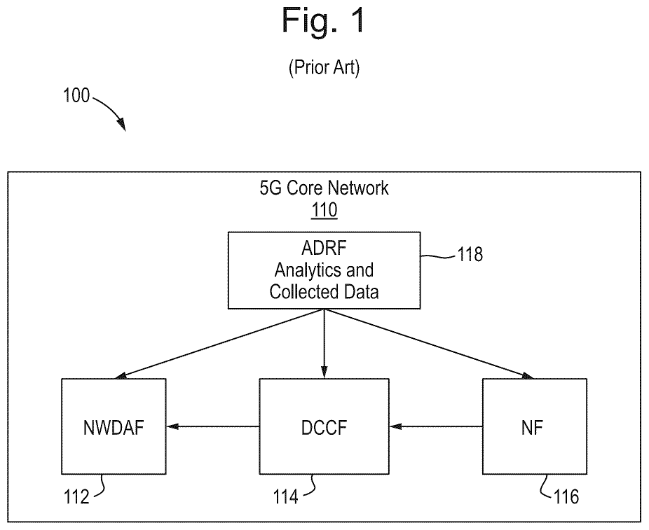

FIG. 1 illustrates a known network data analytics in 5GC, as defined in 3GPP TS 23.288 v17.2.0. The 5G Core Network 110 includes a Network Data Analytics Function (NWDAF) 112, a Data Collection Coordination Function (DCCF) 114, a Network Function (NF) 116, and an Analytics Data Repository Function (ADRF) 118.

The NWDAF 112 comprises analytics services which collect data from the user-plane sessions from the user plane function (UPP) and/or AF. The collected data includes Observed Service Experience related to network data analytics. These may include: Service experience for a UE or a group UEs or any UE in an Application or a set of Applications over a specific UP path (UPF, data network access identifier and edge cloud (EC) server). These may be received from AF, NFs and OAM. Additionally, from UPF the NWDAF 112 may receive: QoS flow bit rate, QoS flow packet delay, # of packet Tx/re-Tx. Further, from AF the NWDAF 112 may receive quality of experience (QoE) metrics, service experience, app location.

The NWDAF 112 may collect WLAN performance analytics such as UE uplink (UL) and/or downlink (DL) data rate and traffic volume. NWDAF 112 may collect UE communication analytics. UE communication analytics may include UE UL/DL data rate and traffic volume from UPF and N4 session level data.

The NWDAF 112 may collect user data congestion analytics. The user data congestion analytics may come from UPF or AF, and may include UL/DL throughput and peak UL/DL throughput. The NWDAF 112 may collect redundant transmission experience related analytics, which may comprise UL/DL packet delay from UE to UPF.

The NWDAF 112 may collect data network performance analytics, which may comprise performance data from AF like Average Packet Delay, Average Loss Rate and Throughput.

The DCCF 114 coordinates the collection and distribution of data requested by network functions (NFs), which are the consumers of this data. These data consumers send requests for data to the DCCF 114. The DCCF 114 coordinates collection of the required data from the appropriate data sources and returns this to the data consumer.

Network Function 116 may be any one network function. Examples of network function 116 are Access and Mobility Management function (AMF); Session Management function (SMF); User plane function (UPF); and Application Function (AF). The AMF supports of Non-Access Stratum (NAS) signaling, connection management, and security context management. The SMF supports session management, UE IP address allocation & management, and traffic steering configuration for UPF for proper traffic routing. The UPF supports packet routing & forwarding, packet inspection, QoS handling. The AF supports application influence on traffic routing, accessing NEF, interaction with policy framework for policy control.

The ADRF 118 stores historical data and/or analytics, i.e. data and/or analytics related to past time period that has been obtained by the data consumer. After the data consumer obtains data and/or analytics, the data consumer may store historical data and/or analytics in the ADRF 118. Whether the data consumer directly contacts the ADRF or goes via the DCCF or via the Messaging Framework is based on configuration.

In TS23.288 v17.2.0, a management data analytics service (MDAS) provides data analytics of different network related parameters including for example load level and/or resource utilization. For example, the MDAS for a network function (NF) can collect the NFs load related performance data, e.g. resource usage status of the NF. The analysis of the collected data is per area, slice or slice subnet, and may provide forecast of resource usage information in a predefined future time. This analysis may also recommend appropriate actions e.g. scaling of resources, admission control, load balancing of traffic, etc.

The DCCF 114 according to TS 23.288 v17.2.0 is limited to coordinating the collection of data from NFs/AF(s) (and OAM), but is unable to coordinate the collection of data from either a UE or an edge node. It follows that the NWDAF 112 cannot provide analytics services on any of: application edge-to-edge (e2e) performance considering data from a UE or an edge node; application related performance analytics when multiple radio access technologies (RATs), networks or radio interfaces are used for the communication; and edge related analytics.

This document defines how to enable the collection of data at the application enablement layer for application data analytics derivation, when the data to be collected are originated from different sources such as a UE, network layer, management system, or an edge platform.

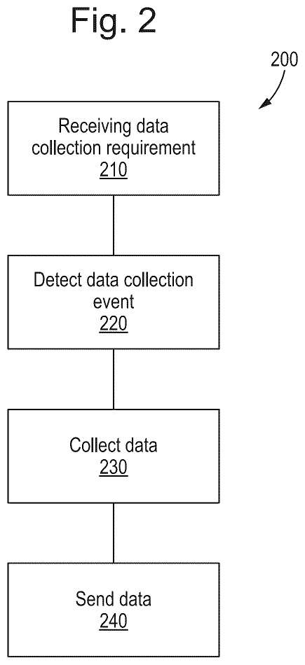

FIG. 2 illustrates a method 200 in a wireless communications device, the method comprising: receiving 210 a data collection requirement from a data collection coordination node, the data collection requirement defining a data collection event associated with application traffic between the wireless communications device and a node within the wireless communications network; detecting 220 the occurrence of the data collection event; collecting 230 data associated with application traffic between the wireless communications device and the node within the wireless communications network in respect of the data collection event; and sending 240 the collected data to the data collection coordination node.

The wireless communications device may comprise a UE or a UE modem. The node within the wireless communications network may comprise one of: an edge node, a data network node, a core network function, an application server, an edge server, an application enabler server, or another wireless communications device. The collection of data may comprise collecting data associated with application traffic in respect of the data collection event between the wireless communications device and a plurality of nodes within the wireless communications network. The plurality of nodes may comprise a plurality of different types of node.

The collection of data in respect of the data collection event comprises collecting data characterizing the communication between the wireless communications device and the node within the wireless communications network, the data collected in respect of communication traffic that satisfies the data collection requirement.

The wireless communications device may comprise a UE modem and one or more application layer entities. An application layer entity may comprise one or more of a vertical application, an application enabler client, a Service Enabler Architecture Layer client, a local application data collection or collection coordination function, an application data analytics enabler client, a Service Enabler Architecture Layer Data Delivery client, and an application client.

The data collection coordination node may be arranged to send a data collection requirement to a plurality of wireless communications devices, the plurality of wireless communications devices including the wireless communications device, such that the data collection coordination node may collect data regarding application traffic for a particular application amongst the plurality of wireless communications devices. The data collection coordination node may collect data regarding application traffic between an application server and the plurality of wireless communications devices. The plurality of wireless communications devices may be defined according to a selection criterion. The selection criterion may be a geographical limitation. The geographical limitation may be all wireless communications devices in a particular geographical area at a particular time. The plurality of wireless communications devices may be selected as a subset of wireless communications devices that satisfy a selection criterion. The selected subset may be randomly selected from the set of all wireless communications devices that satisfy a selection criterion. The selection may also be arbitrary and/or non-random.

The method may further comprise processing the collected data before sending the collected data to the data collection coordination node. The processing of the collected data may comprise filtering. The processing of the collected data may comprise an averaging operation. The processing of the received collected data may comprise an abstraction of one or more of: control plane data, user plane data, management plane data, edge platform data. The method may further comprise storing the set of processed to data.

The control plane data may correspond to data being exposed by a 3GPP defined control plane network function (5GC or RAN control function). Data from a RAN control function can be exposed by the edge node or a RAN Intelligent Controller and relates to the output of a Radio Resource Management (RRM) function. The user plane data may correspond to data derived from networking stacks from the user plane function or the data network. The management plane data may correspond to data exposed by a 3GPP management domain and/or OAM. The edge platform data area data may correspond to the performance or load of the edge platform where the application server resides, or data derived from the constituent segments of the end to end session.

The data collection requirement may include at least one of: parameters to be collected for the data collection event; the resolution at which data is to be collected; an event identity identifying the data collection event; a time validity; a geographical area; an application service area; an application identity; and conditions for triggering the data collection event.

The resolution at which data is to be collected may comprise a measuring interval defining a frequency at which a parameter is to be measured. The resolution at which data is to be collected may comprise a degree of accuracy at which a parameter is to be measured. Where collected data is reported without processing, the resolution at which data is to be collected defines the resolution at which data is to be reported. Where collected data is processed before reporting, the resolution at which data is to be reported may be defined. The resolution at which data is reported may be different to the resolution at which data is to be collected. For example, the processing may comprise taking a plurality of measurements of a parameter at time intervals, processing these to find an average and periodically reporting the average. The data collection requirement may also comprise a reporting requirement. The reporting requirement may comprise one of: real-time, near-real-time, offline.

The data collection event may comprise at least one of: an end-to-end application performance related event for the application traffic associated with the wireless communication device; an end-to-end application performance related event for the application traffic associated with the wireless communication device and an application server; an end-to-end application performance related event for the application traffic associated with the wireless communication device and one or more further wireless communication devices; an application server performance related event, and a change of application traffic parameters.

The end-to-end application performance may be calculated at the wireless communications device or at the DN/application server. The end-to-end application performance may comprise one or more of the following parameters: an application QoS parameter (e.g. latency, jitter, data rate, packet error rate (PER) and/or reliability), a QoE parameter (e.g. Mean Opinion Score (MOS), stalling events, stalling ratio, buffering, rate and resolution changes) for the end to end application session and/or service, or a key performance indicator for the end to end session. The application server performance is calculated at the DN/application server side and comprises one or more of an application QoS (e.g. latency, jitter, data rate, PER/reliability), a QoE parameter (e.g. Mean Opinion Score (MOS), stalling events, stalling ratio, buffering, rate and resolution changes), application server load indication, and an edge node load indication corresponding to the application server. For the QoS and QoE parameters, the application server performance is calculated (the calculation may include an averaging step) based on the performance of a plurality of end-to-end application sessions which are served by the application server for a given application server service area.

Detecting the occurrence of the data collection event comprises at least one of: initiation of a communication related to the application traffic; modification of one or more performance parameters related to the application traffic; a modification or termination of a communication related to the application traffic; and a deviation of a performance parameter from a desirable key performance indicator related to the application traffic.

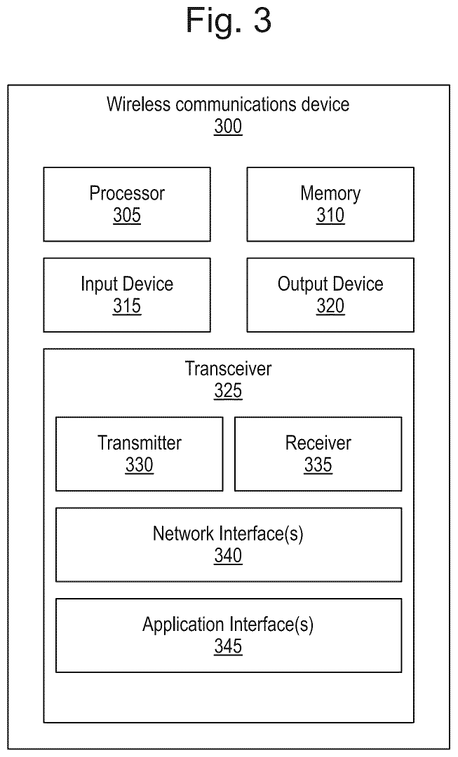

FIG. 3 depicts a user equipment apparatus 300 that may be used for implementing the methods described herein. The user equipment apparatus 300 includes a processor 305, a memory 310, an input device 315, an output device 320, and a transceiver 325.

The input device 315 and the output device 320 may be combined into a single device, such as a touchscreen. In some implementations, the user equipment apparatus 300 does not include any input device 315 and/or output device 320. The user equipment apparatus 300 may include one or more of: the processor 305, the memory 310, and the transceiver 325, and may not include the input device 315 and/or the output device 320.

As depicted, the transceiver 325 includes at least one transmitter 330 and at least one receiver 335. The transceiver 325 may communicate with one or more cells (or wireless coverage areas) supported by one or more base units. The transceiver 325 may be operable on unlicensed spectrum. Moreover, the transceiver 325 may include multiple UE panels supporting one or more beams. Additionally, the transceiver 325 may support at least one network interface 340 and/or application interface 345. The application interface(s) 345 may support one or more APIs. The network interface(s) 340 may support 3GPP reference points, such as Uu, N1, PC5, etc. Other network interfaces 340 may be supported, as understood by one of ordinary skill in the art.

The processor 305 may include any known controller capable of executing computer-readable instructions and/or capable of performing logical operations. For example, the processor 305 may be a microcontroller, a microprocessor, a central processing unit (“CPU”), a graphics processing unit (“GPU”), an auxiliary processing unit, a field programmable gate array (“FPGA”), or similar programmable controller. The processor 305 may execute instructions stored in the memory 310 to perform the methods and routines described herein. The processor 305 is communicatively coupled to the memory 310, the input device 315, the output device 320, and the transceiver 325.

The processor 305 may control the user equipment apparatus 300 to implement the above-described UE behaviors. The processor 305 may include an application processor (also known as “main processor”) which manages application-domain and operating system (“OS”) functions and a baseband processor (also known as “baseband radio processor”) which manages radio functions.

The memory 310 may be a computer readable storage medium. The memory 310 may include volatile computer storage media. For example, the memory 310 may include a RAM, including dynamic RAM (“DRAM”), synchronous dynamic RAM (“SDRAM”), and/or static RAM (“SRAM”). The memory 310 may include non-volatile computer storage media. For example, the memory 310 may include a hard disk drive, a flash memory, or any other suitable non-volatile computer storage device. The memory 310 may include both volatile and non-volatile computer storage media.

The memory 310 may store data related to implement a traffic category field as describe above. The memory 310 may also store program code and related data, such as an operating system or other controller algorithms operating on the apparatus 300.

The input device 315 may include any known computer input device including a touch panel, a button, a keyboard, a stylus, a microphone, or the like. The input device 315 may be integrated with the output device 320, for example, as a touchscreen or similar touch-sensitive display. The input device 315 may include a touchscreen such that text may be input using a virtual keyboard displayed on the touchscreen and/or by handwriting on the touchscreen. The input device 315 may include two or more different devices, such as a keyboard and a touch panel.

The output device 320 may be designed to output visual, audible, and/or haptic signals. The output device 320 may include an electronically controllable display or display device capable of outputting visual data to a user. For example, the output device 320 may include, but is not limited to, a Liquid Crystal Display (“LCD”), a light-Emitting Diode (“LED”) display, an Organic LED (“OLED”) display, a projector, or similar display device capable of outputting images, text, or the like to a user. As another, non-limiting, example, the output device 320 may include a wearable display separate from, but communicatively coupled to, the rest of the user equipment apparatus 300, such as a smart watch, smart glasses, a heads-up display, or the like. Further, the output device 320 may be a component of a smart phone, a personal digital assistant, a television, a table computer, a notebook (laptop) computer, a personal computer, a vehicle dashboard, or the like.

The output device 320 may include one or more speakers for producing sound. For example, the output device 320 may produce an audible alert or notification (e.g., a beep or chime). The output device 320 may include one or more haptic devices for producing vibrations, motion, or other haptic feedback. All, or portions, of the output device 320 may be integrated with the input device 315. For example, the input device 315 and output device 320 may form a touchscreen or similar touch-sensitive display. The output device 320 may be located near the input device 315.

The transceiver 325 communicates with one or more network functions of a mobile communication network via one or more access networks. The transceiver 325 operates under the control of the processor 305 to transmit messages, data, and other signals and also to receive messages, data, and other signals. For example, the processor 305 may selectively activate the transceiver 325 (or portions thereof) at particular times in order to send and receive messages.

The transceiver 325 includes at least one transmitter 330 and at least one receiver 335. The one or more transmitters 330 may be used to provide UL communication signals to a base unit of a wireless communications network. Similarly, the one or more receivers 335 may be used to receive DL communication signals from the base unit. Although only one transmitter 330 and one receiver 335 are illustrated, the user equipment apparatus 300 may have any suitable number of transmitters 330 and receivers 335. Further, the transmitter(s) 330 and the receiver(s) 335 may be any suitable type of transmitters and receivers. The transceiver 325 may include a first transmitter/receiver pair used to communicate with a mobile communication network over licensed radio spectrum and a second transmitter/receiver pair used to communicate with a mobile communication network over unlicensed radio spectrum.

The first transmitter/receiver pair may be used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. The first transmitter/receiver pair and the second transmitter/receiver pair may share one or more hardware components. For example, certain transceivers 325, transmitters 330, and receivers 335 may be implemented as physically separate components that access a shared hardware resource and/or software resource, such as for example, the network interface 340.

One or more transmitters 330 and/or one or more receivers 335 may be implemented and/or integrated into a single hardware component, such as a multi-transceiver chip, a system-on-a-chip, an Application-Specific Integrated Circuit (“ASIC”), or other type of hardware component. One or more transmitters 330 and/or one or more receivers 335 may be implemented and/or integrated into a multi-chip module. Other components such as the network interface 340 or other hardware components/circuits may be integrated with any number of transmitters 330 and/or receivers 335 into a single chip. The transmitters 330 and receivers 335 may be logically configured as a transceiver 325 that uses one more common control signals or as modular transmitters 330 and receivers 335 implemented in the same hardware chip or in a multi-chip module.

The wireless communications device 300 may implement the methods described herein as follows. The receiver 335 is arranged to receive a data collection requirement from a data collection coordination node, the data collection requirement defining a data collection event associated with application traffic between the wireless communications device and a node within the wireless communications network. The processor 305 is arranged to: detect the occurrence of the data collection event; and collect data associated with application traffic between the wireless communications device and a node within the wireless communications network in respect of the data collection event. The transmitter 330 is arranged to send the collected data to the data collection coordination node.

The wireless communications device 300 may comprise a UE or a UE modem. The node within the wireless communications network may comprise an edge node or another wireless communications device. The collection of data in respect of the data collection event comprises collecting data characterizing the communication between the wireless communications device and the node within the wireless communications network, the data collected in respect of communication traffic that satisfies the data collection requirement. The wireless communications device may comprise a UE modem and an application layer entity. The application layer entity may comprise one or more of a vertical application, an application enabler client, a Service Enabler Architecture Layer client, and an application client.

The data collection coordination node may be arranged to send a data collection requirement to a plurality of wireless communications devices, the plurality of wireless communications devices including the wireless communications device, such that the data collection coordination node may collect data regarding application traffic for a particular application amongst the plurality of wireless communications devices. The data collection coordination node may collect data regarding application traffic between an application server and the plurality of wireless communications devices. The plurality of wireless communications devices may be defined according to a selection criterion. The selection criterion may be a geographical limitation. The geographical limitation may be all wireless communications devices in a particular geographical area at a particular time. The plurality of wireless communications devices may be selected as a subset of wireless communications devices that satisfy a selection criterion. The selected subset may be randomly selected from the set of all wireless communications devices that satisfy a selection criterion. The selection may also be arbitrary and/or non-random.

The processor 305 may be further arranged to process the collected data before sending the collected data to the data collection coordination node. The processing of the collected data may comprise filtering. The processing of the collected data may comprise an averaging operation. The processing of the received collected data may comprise an abstraction of one or more of: control plane data, user plane data, management plane data, edge platform data. The method may further comprise storing the set of processed data.

The data collection requirement includes at least one of: parameters to be collected for the data collection event; the resolution at which data is to be collected; an event identity identifying the data collection event; a time validity; a geographical area; an application service area; an application identity; and conditions for triggering the data collection event.

The resolution at which data is to be collected may comprise a measuring interval defining a frequency at which a parameter is to be measured. The resolution at which data is to be collected may comprise a degree of accuracy at which a parameter is to be measured. Where collected data is reported without processing, the resolution at which data is to be collected defines the resolution at which data is to be reported. Where collected data is processed before reporting, the resolution at which data is to be reported may be defined. The resolution at which data is reported may be different to the resolution at which data is to be collected. For example, the processing may comprise taking a plurality of measurements of a parameter at time intervals, processing these to find an average and periodically reporting the average. The data collection requirement may also comprise a reporting requirement. The reporting requirement may comprise one of: real-time, near-real-time, offline.

The data collection event comprises at least one of: an end-to-end application performance related event for the application traffic associated with the wireless communication device; an end-to-end application performance related event for the application traffic associated with the wireless communication device and an application server; an end-to-end application performance related event for the application traffic associated with the wireless communication device and one or more further wireless communication devices; an application server performance related event; and a change of application traffic parameters.

The processor 305 may be arranged to detect the occurrence of the data collection event comprises at least one of: initiation of a communication related to the application traffic; modification of one or more performance parameters related to the application traffic; a modification or termination of a communication related to the application traffic; and a deviation of a performance parameter from a desirable key performance indicator related to the application traffic.

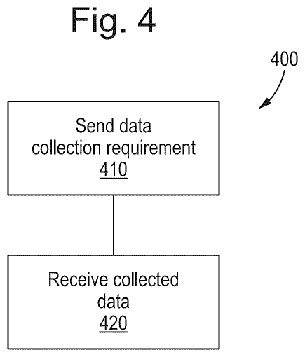

FIG. 4 illustrates a method 400 in a data collection node, the method 400 comprising sending 410 a first data collection requirement to a wireless communications device, the first data collection requirement defining a first data collection event associated with application traffic between the wireless communications device and a node within the wireless communications network; and receiving 420 collected data associated with application traffic between the wireless communications device and the node within the wireless communications network in respect of the data collection event.

The data collection coordination node may be arranged to send a data collection requirement to a plurality of wireless communications devices, the plurality of wireless communications devices including the wireless communications device, such that the data collection coordination node may collect data regarding application traffic for a particular application amongst the plurality of wireless communications devices. The data collection coordination node may collect data regarding application traffic between an application server and the plurality of wireless communications devices. The plurality of wireless communications devices may be defined according to a selection criterion. The selection criterion may be a geographical limitation. The geographical limitation may be all wireless communications devices in a particular geographical area at a particular time. The plurality of wireless communications devices may be selected as a subset of wireless communications devices that satisfy a selection criterion. The selected subset may be randomly selected from the set of all wireless communications devices that satisfy a selection criterion. The selection may also be arbitrary and/or non-random.

The method 400 may further comprise sending a second data collection requirement to an edge node, the second data collection requirement defining a second data collection event associated with the operation of the edge node; and receiving collected data associated with the second data collection requirement.

The second data collection event may be triggered by the location of a wireless communications device. For example, if a wireless communications device connected to the edge node encounters a first data collection event, this may trier a second data collection event dependent thereon. The second data collection requirement may comprise a measure of the performance of the edge node. Such a performance measurement may comprise a measure of processing delays, load, and/or the performance related to the radio access network.

Such data may help a processing and/or abstraction step at the data collection coordination node and accordingly may also provide useful data to the consumer. For example, the location of the wireless communications device may be used by the data collection coordination node to identify that these performance measurements were at certain area of the cell. Similarly, radio access network performance measurements help identifying possible delays at the radio access network side.

The method 400 may further comprise receiving collected data from a plurality of wireless communications devices, one or more data network nodes, a management domain node, an application server, or a combination thereof.

The first and/or second data collection event comprise at least one of: parameters to be collected; the resolution at which data is to be collected; an event identity; a time validity; a geographical area; an application service area; an application identity; and conditions for triggering the data collection event.

The resolution at which data is to be collected may comprise a measuring interval defining a frequency at which a parameter is to be measured. The resolution at which data is to be collected may comprise a degree of accuracy at which a parameter is to be measured. Where collected data is reported without processing, the resolution at which data is to be collected defines the resolution at which data is to be reported. Where collected data is processed before reporting, the resolution at which data is to be reported may be defined. The resolution at which data is reported may be different to the resolution at which data is to be collected. For example, the processing may comprise taking a plurality of measurements of a parameter at time intervals, processing these to find an average and periodically reporting the average. The data collection requirement may also comprise a reporting requirement. The reporting requirement may comprise one of: real-time, near-real-time, offline. The method 400 may further comprise storing the collected data.

The first and/or second data collection event comprise at least one of: an end-to-end application performance related event for the application traffic; an end-to-end application performance related event for the application traffic; an end-to-end application performance related event for the application traffic associated with the wireless communication device and one or more further wireless communication devices; an edge data network performance related event, a radio access network performance related event; a wireless communication device location event; an application server performance related event; and an application traffic parameters change event.

The application traffic may comprise application traffic between the edge node and the server, the wireless communications device and the server, or a pair of wireless communications devices.

The method 400 may further comprise storing the received collected data. The method 400 may further comprise generating a set of processed data based on the one or more received collected data.

The processing of the collected data may comprise filtering. The processing of the collected data may comprise an averaging operation. The processing of the received collected data may comprise an abstraction of one or more of: control plane data, user plane data, management plane data, edge platform data. The method 400 may further comprise storing the set of processed data.

The method 400 may further comprise transmitting the set of processed data to an external entity. The external entity may be an application data analytics service provider. Alternatively, the received collected data may be stored, and/or transmitted to the external entity.

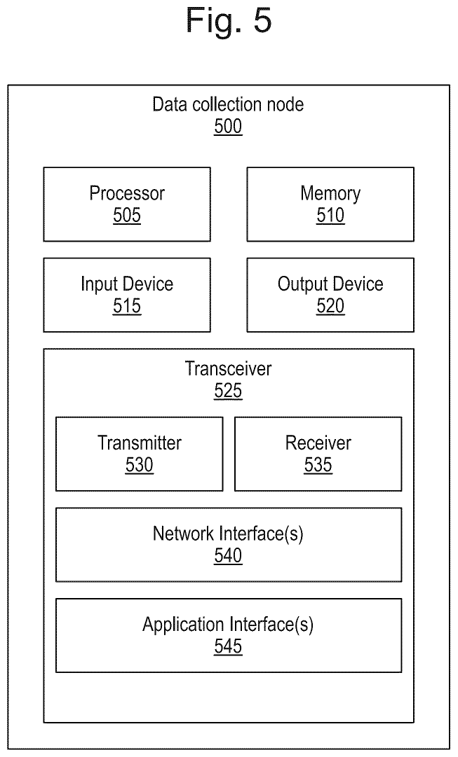

FIG. 5 depicts further details of the network node 500 that may be used for implementing the methods described herein. The network node 500 may be one implementation of an entity in the wireless communications network. The network node 500 includes a processor 505, a memory 510, an input device 515, an output device 520, and a transceiver 525.

The input device 515 and the output device 520 may be combined into a single device, such as a touchscreen. In some implementations, the network node 500 does not include any input device 515 and/or output device 520. The network node 500 may include one or more of: the processor 505, the memory 510, and the transceiver 525, and may not include the input device 515 and/or the output device 520.

As depicted, the transceiver 525 includes at least one transmitter 530 and at least one receiver 535. Here, the transceiver 525 communicates with one or more remote units 200. Additionally, the transceiver 525 may support at least one network interface 540 and/or application interface 545. The application interface(s) 545 may support one or more APIs. The network interface(s) 540 may support 3GPP reference points, such as Uu, N1, N2 and N3. Other network interfaces 540 may be supported, as understood by one of ordinary skill in the art.

The processor 505 may include any known controller capable of executing computer-readable instructions and/or capable of performing logical operations. For example, the processor 505 may be a microcontroller, a microprocessor, a CPU, a GPU, an auxiliary processing unit, a FPGA, or similar programmable controller. The processor 505 may execute instructions stored in the memory 510 to perform the methods and routines described herein. The processor 505 is communicatively coupled to the memory 510, the input device 515, the output device 520, and the transceiver 525.

The memory 510 may be a computer readable storage medium. The memory 510 may include volatile computer storage media. For example, the memory 510 may include a RAM, including dynamic RAM (“DRAM”), synchronous dynamic RAM (“SDRAM”), and/or static RAM (“SRAM”). The memory 510 may include non-volatile computer storage media. For example, the memory 510 may include a hard disk drive, a flash memory, or any other suitable non-volatile computer storage device. The memory 510 may include both volatile and non-volatile computer storage media.

The memory 510 may store data related to establishing a multipath unicast link and/or mobile operation. For example, the memory 510 may store parameters, configurations, resource assignments, policies, and the like, as described above. The memory 510 may also stores program code and related data, such as an operating system or other controller algorithms operating on the network node 500.

The input device 515 may include any known computer input device including a touch panel, a button, a keyboard, a stylus, a microphone, or the like. The input device 515 may be integrated with the output device 520, for example, as a touchscreen or similar touch-sensitive display. The input device 515 may include a touchscreen such that text may be input using a virtual keyboard displayed on the touchscreen and/or by handwriting on the touchscreen. The input device 515 may include two or more different devices, such as a keyboard and a touch panel.

The output device 520 may be designed to output visual, audible, and/or haptic signals. The output device 520 may include an electronically controllable display or display device capable of outputting visual data to a user. For example, the output device 520 may include, but is not limited to, an LCD display, an LED display, an OLED display, a projector, or similar display device capable of outputting images, text, or the like to a user. As another, non-limiting, example, the output device 520 may include a wearable display separate from, but communicatively coupled to, the rest of the network node 500, such as a smart watch, smart glasses, a heads-up display, or the like. Further, the output device 520 may be a component of a smart phone, a personal digital assistant, a television, a table computer, a notebook (laptop) computer, a personal computer, a vehicle dashboard, or the like.

The output device 520 may include one or more speakers for producing sound. For example, the output device 520 may produce an audible alert or notification (e.g., a beep or chime). The output device 520 may include one or more haptic devices for producing vibrations, motion, or other haptic feedback. All, or portions, of the output device 520 may be integrated with the input device 515. For example, the input device 515 and output device 520 may form a touchscreen or similar touch-sensitive display. The output device 520 may be located near the input device 515.

The transceiver 525 includes at least one transmitter 530 and at least one receiver 535. The one or more transmitters 530 may be used to communicate with the UE, as described herein. Similarly, the one or more receivers 535 may be used to communicate with network functions in the public land mobile network (PLMN) and/or radio access network (RAN), as described herein. Although only one transmitter 530 and one receiver 535 are illustrated, the network node 500 may have any suitable number of transmitters 530 and receivers 535. Further, the transmitter(s) 530 and the receiver(s) 535 may be any suitable type of transmitters and receivers.

The data collection coordination node 500 may implement the methods described herein as follows. The transmitter 530 is arranged to send a first data collection requirement to a wireless communications device, the first data collection requirement defining a first data collection event associated with application traffic between the wireless communications device and a node within the wireless communications network. The receiver 535 is arranged to receive collected data associated with application traffic between the wireless communications device and the node within the wireless communications network in respect of the data collection event.

The data collection coordination node may further comprise a processor 505 arranged to process the received collected data to generate a set of processed data.

The data collection coordination node may be arranged to send a data collection requirement to a plurality of wireless communications devices, the plurality of wireless communications devices including the wireless communications device, such that the data collection coordination node may collect data regarding application traffic for a particular application amongst the plurality of wireless communications devices. The data collection coordination node may collect data regarding application traffic between an application server and the plurality of wireless communications devices. The plurality of wireless communications devices may be defined according to a selection criterion. The selection criterion may be a geographical limitation. The geographical limitation may be all wireless communications devices in a particular geographical area at a particular time. The plurality of wireless communications devices may be selected as a subset of wireless communications devices that satisfy a selection criterion. The selected subset may be randomly selected from the set of all wireless communications devices that satisfy a selection criterion. The selection may also be arbitrary and/or non-random.

The transmitted may be further arranged to send a second data collection requirement to an edge node, the second data collection requirement defining a second data collection event associated with the operation of the edge node. The receiver 535 may be further arranged to receive collected data associated with the second data collection requirement.

The second data collection event may be triggered by the location of a wireless communications device. For example, if a wireless communications device connected to the edge node encounters a first data collection event, this may trigger a second data collection event dependent thereon. The second data collection requirement may comprise a measure of the performance of the edge node. Such a performance measurement may comprise a measure of processing delays, load, and/or the performance related to the radio access network. Such data may help a processing and/or abstraction step at the data collection coordination node and accordingly may also provide useful data to the consumer. For example, the location of the wireless communications device may be used by the data collection coordination node to identify that these performance measurements were at certain area of the cell. Similarly, radio access network performance measurements help identifying possible delays at the radio access network side.

The receiver 535 may be further arranged to receive collected data from a plurality of wireless communications devices, one or more data network nodes, a management domain node, an application server, or a combination thereof. The first and/or second data collection events may comprise at least one of: parameters to be collected; the resolution at which data is to be collected; an event identity; a time validity; a geographical area; an application service area; an application identity; and conditions for triggering the data collection event.

The resolution at which data is to be collected may comprise a measuring interval defining a frequency at which a parameter is to be measured. The resolution at which data is to be collected may comprise a degree of accuracy at which a parameter is to be measured. Where collected data is reported without processing, the resolution at which data is to be collected defines the resolution at which data is to be reported. Where collected data is processed before reporting, the resolution at which data is to be reported may be defined. The resolution at which data is reported may be different to the resolution at which data is to be collected. For example, the processing may comprise taking a plurality of measurements of a parameter at time intervals, processing these to find an average and periodically reporting the average. The data collection requirement may also comprise a reporting requirement. The reporting requirement may comprise one of: real-time, near-real-time, offline. The method may further comprise storing the collected data.

The first and/or second data collection events may comprise at least one of: an end-to-end application performance related event for the application traffic; an end-to-end application performance related event for the application traffic; an end-to-end application performance related event for the application traffic associated with the wireless communication device and one or more further wireless communication devices; an edge data network performance related event; a radio access network performance related event; a wireless communication device location event; an application server performance related event; and an application traffic parameters change event.

The application traffic may comprise application traffic between the edge node and the server, the wireless communications device and the server, or a pair of wireless communications devices. The data collection coordination node may further comprise a data storage arranged to store the received collected data.

The data collection coordination node may further comprise a processor 505 arranged to generate a set of processed data based on the one or more received collected data. The processing of the collected data may comprise filtering. The processing of the collected data may comprise an averaging operation. The processing of the received collected data may comprise an abstraction of one or more of: control plane data, user plane data, management plane data, edge platform data. The data collection coordination node may further comprise a data storage arranged to store the processed data.

The transmitter 530 may be further arranged to transmit the set of processed data to an external entity. The external entity may be an application data analytics service provider. Alternatively, the received collected data may be stored, and/or transmitted to the external entity.

There is described herein a mechanism for collecting user-plane data at a middleware platform or enabler layer and providing data related to the data network operation to an external entity. The data related to the network operation may include data network or application session QoS or application service performance. The data related to the network operation may include processed collected data. The processed collected data may include statistics derived from the collected data. The external entity may be a vertical service provider or an application service provider.

There is described herein a global application data collection coordination function (G-ADCCF), residing at the data network side, which monitors application session data (from PDU layer) as well as historical data on the data network/app server performance. The G-ADCCF may abstract data collected from an N6 endpoint at the data network (or UPF) based on the level of abstraction required by the external entity. By way of example, the external entity may require the averaged round trip time (RTT) for certain application traffic or the average RTT in peak hours/certain areas. This function may also be part of a service function chain and may listen to application data via smart DPI. In certain implementations this can be a Service Enabler Architecture Layer Data Delivery server or another application enablement or middleware server.

There is further provided a local application data collection coordination function (L-ADCCF). The L-ADCCF as a client that resides in the UE. The L-ADCCF client collects data from both on-network and off-network sessions and optionally abstracts this data based on external entity needs. Off-network sessions may include PC5 sessions, which are device-to-device communications, that include Cellular Vehicle-to-Everything (C-V2X). In certain implementations this can be a Service Enabler Architecture Layer Data Delivery client or another application enablement/middleware client.

The requesting entity may be a data consumer. The data consumer that uses the ADCCF services might be, for example, an application data analytics enabler function (ADAEF). Such function can have a server and a client counterpart at the data network and UE accordingly. Such counterparts may be an Application Data Analytics Enabler Server (ADAES) and an Application Data Analytics Enabler Client (ADAEC). The ADAEF collects data from the ADCCF and produces analytics based on the requesting entities requirements. The server side of ADAEF can be seen as an AF which may consume northbound NEF and OAM services. The client side of ADEAF may collect day from L-ADCCF at the UE and provide these to ADAES based on reporting requirements configured by the ADCCF. The reporting requirements may be requested by the requesting entity.

Operation data is collected, processed as necessary and reported to the requesting entity. Typically, the collected data is stored in a storing entity (e.g. ADRF or VAL DB), which may include a database. Depending on storage requirements, either the collected data or the processed data is stored. Such storage may be required where the requested data spans a period of time and is to be delivered once the collection period is complete. Data reported in response to requests may also be stored to facilitate to facilitate ease of response to future requests for the same or similar operational data.

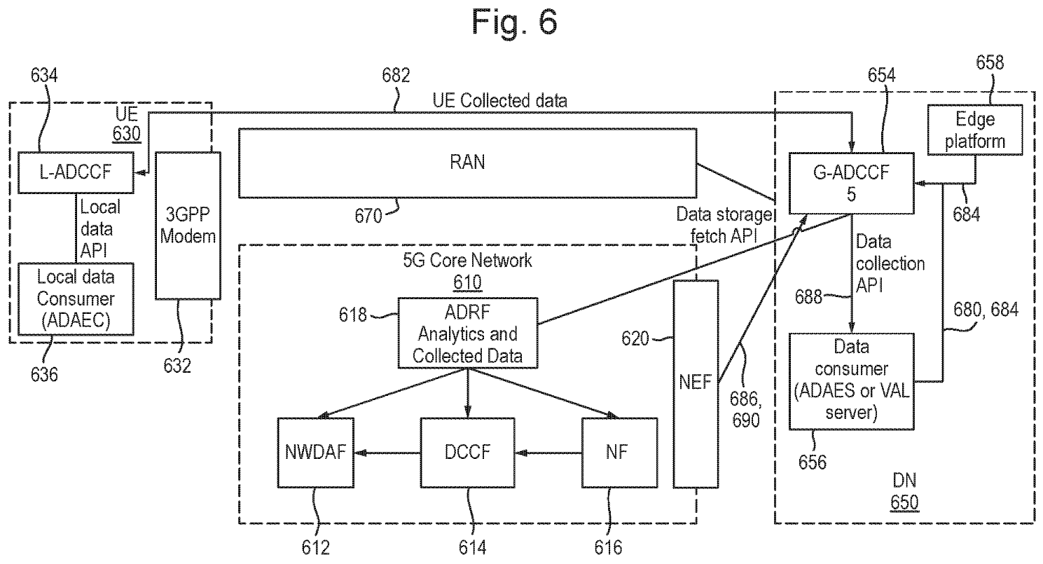

FIG. 6 illustrates a proposed architecture for performance data collection in a wireless communications network. The system 600 of FIG. 6 comprises a 5G core network 610, a UE 630 and a data network (DN) node 650. The 5G Core Network 610 includes a Network Data Analytics Function (NWDAF) 612, a Data Collection Coordination Function (DCCF) 614, a Network Function (NF) 616, an Analytics Data Repository Function (ADRF) 618, and a Network Exposure Function (NEF) 620. The UE 630 communicates with the data network 650 over a radio access network 670. The radio access network 670 may comprise a 5G cellular network. The UE 630 may comprise a UE 300 as described above. The data network node 650 may comprise a data collection node 500 as describe above. The UE 630 includes a 3GPP modem 632, an L-ADCCF 634 and a local data consumer (ADAEC) 636. The data network node 650 may comprise a data collection node 500. The data network node 650 comprises a G-ADCCF 654, a data consumer 656, and an edge platform 658. The data consumer 656 may comprise an ADAES of a Vertical Application Layer server.

The operation of the system 600 will now be described. At 680, the data consumer 656 subscribes to the G-ADCCF 654 by sending a subscription request to the G-ADCCF 654. The subscription request indicates to the G-ADCCF 654 that the data consumer 656 requires data based on a particular event identity and a target. The event identity may be an application server performance data. The target may be a target area or a target UE. The subscription request configures the level of abstraction for the data to be collected. The level of abstraction may be based on the application profile and/or vertical and the KPIs for the application service. The G-ADCCF 654 then identifies the data producers required to fulfil the subscription request. Based on the received event identity, the data producers will identify what data are needed to be reported.

Additionally, the G-ADCCF 654 may identify the temporal reporting requirements of the subscription request. The temporal reporting requirements dictate whether the data must be provided real-time (while the application session is running) and/or offline (for example, before session starts to identify the stats on server performance). The subscription request further defines the level of abstraction of the data to be reported. If no abstraction is required, then raw data is reported. Typically, a level of abstraction is defined which determines a degree and amount of processing performed in the collected data before it is reported to the data consumer 656. The processing of collected data may comprise statistical analysis, correlation, averaging, filtering, combining with other data. The processing may be performed in respect of a given area, time and type of request.

For example, the subscription request may require all RTT data for a given time and area, such as a hotspot area at peak hours, but for non-peak hours provide only an average RT value. Such specificity in a reporting arrangement reduces the amount of information that must be transferred between nodes in the network to answer an information request. Non-peak hours may be defined in the subscription request, non-peak hours may be defined as when the communication load is below a particular threshold value. That threshold value may be defined in the subscription request.

At 682, the G-ADCCF 654 requests and receives local application data from L-ADCCF 634 in the UE 630 about any ongoing application sessions based on the event identity define din the subscription request. Prior to this, the ADAES 656 may also configure the L-ADCCF 634 to report data. Such configuring may comprise defining: the metrics required, and the abstraction required for each event identity.

The required abstraction may be defined according to the following examples of limitations on reported data.
Measurements from application layer (enabler layer or specific layer) based on the real-time performance of the application session. For example, application traffic may be passed via the SEALDD (Service Enabler Architecture Layer for Verticals Data Delivery) client at the UE, this may include the packet losses, number of message retransmissions, and the experienced latency and failures.
Application traffic parameters (such as time schedules) for the application session.
Per slice measurements. If a slice enabler client knows the slice to which the UE is connected to then it can gather measurements per slice. This may be used to obtain stats per slice for future selections and/or preference setting.
Performance measurements from networking layers and/or PDU layer at the UE side.
Measurements from the access stratum. Such measurements may comprise 12 measurements.
Per radio access technology (RAT) measurements, and/or per interface measurements. These are measurements from the application layer or networking layer based on the type of communication. For example, only PC5 measurements may be needed where the area of interest is C-V2X.
Per PLMN measurements. The UE 630 may connect to multiple PLMNs for a multi-operator service.

At 684, the G-ADCCF 654 also fetches data from other data sources. Data in respect of the event identity of interest may be obtained from other data sources.
Networking layers (TCP/QUIC/IP/Ethernet): based on the transport protocols used. Data provided by networking layers may include RTT, delay and packet loss rates.
Application server, which can provide real-time data to G-ADCCF 654. Such real time data may comprise the active delivery of UE trajectories and/or routes. Such real time data may be delivered passively if the enabler layer supports the application traffic delivery, then the enabler server can calculate QoS/QoE metrics for the end-to-end application session. The enabler layer entity can be for example a SEALDD server, an Edge Enabler Server, a V2X Application Enabler server, or an AF at the data network where the application server resides.
Edge/cloud platform, which may provide edge/cloud load measurements, edge server load/conditions, number of API invocations for a given area and time, edge service availability stats, number of completed transactions, edge platform/service failure rates, edge service uptime/downtime stats, cached application data
5GC/OAM: network and service layer agreement monitoring via NEF/exposable Management Services (via OAM APIs).

At 686, the G-ADCCF 654 requests and receives historical data from ADRF 618 in respect of the event identity.

At 688, the G-ADCCF 654 abstracts the data received in steps 68Z 684, and 686 and sends the abstracted data to the subscribing entity, which in this case is data consumer 656. The abstracted data is sent based on the data requirements defined in the subscription request. The abstracted data is sent as it is collected and processed if real time reporting is specified. If non real time reporting is specified then the abstracted data is saved until a complete abstracted data set is formed, the abstracted data set is then sent to the data consumer 656 offline.

At 690, the G-ADCCF 654 may also store in the ADRF 618 the online data and/or abstracted data produced at G-ADCCF 654. The G-ADCCF 654 may also store in the ADRF 618 the online data and/or abstracted data produced by and received from the L-ADCCF 634. Data storage may be performed via the NEF 620. Alternatively, the G-ADCCF 654 may store the data to an external database. The external database may be within the same domain as the G-ADCCF 654.

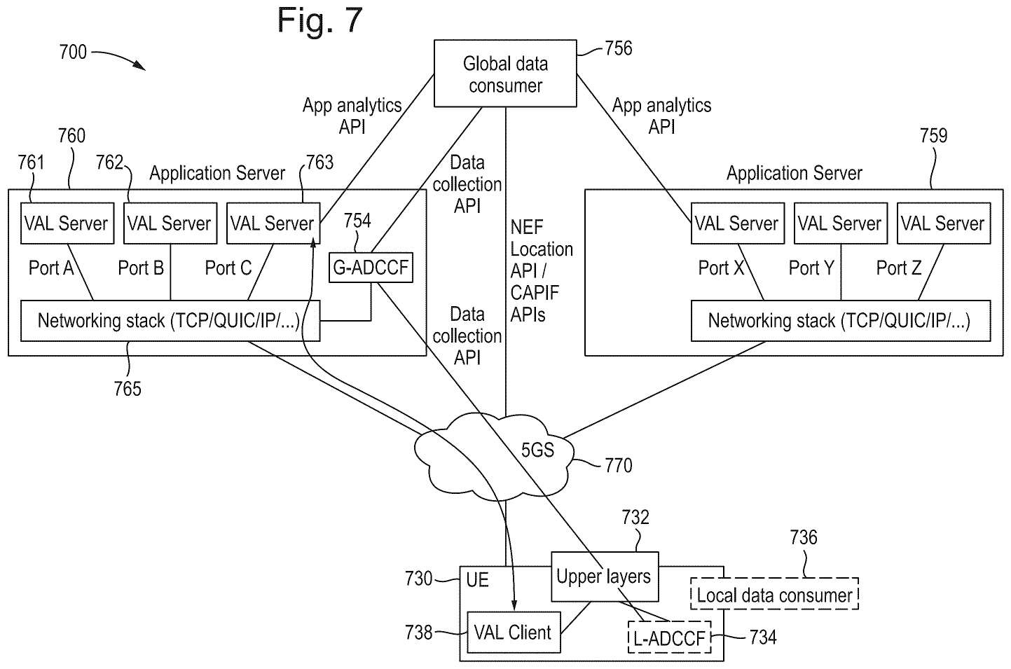

FIG. 7 illustrates an example system wherein a round trip time (RTT) metric is collected and reported. The system 700 comprises a global data consumer 756, application servers 757 and 760, a 5G system 770, and a UE 730. The global data consumer 756 may comprise a Vertical Application Layer (VAL) or an ADAES. The application server 760 comprises a G-ADCCF 754, a first VAL server 761, a second VAL server 762, a third VAL server 763, and a networking stack 765. The first VAL server 761 communicates with the networking stack 765 using port A, the second VAL server 762 communicates with the networking stack 765 using port B, and the third VAL server 763 communicates with the networking stack 765 using port C. The UE 730 comprises a VAL client 738, a upper layers 732, an L-ADCCF 734 and a local data consumer 736. The UE 730 may comprise a wireless communications device 300 as described above. The application server 760 may comprise a data collection node 500 as describe above.

The global data consumer 756 sends a performance data request to the G-ADCCF 754 in application server 760. The performance data request specifies collection of performance data for traffic between UE 730 and application server 760 in a particular window of time, here the month of June. The performance data request additional specifies the performance data to be collected is the round-trip time (RTT) and an associated quality of service flow indicator (QFI). The G-ADCCF 754 instructs the L-ADCCF 734 in UE 730 to collect data required from the UE to fulfill the performance data request. When the criteria of the performance data request are fulfilled, i.e. traffic between UE 732 and application server 760 in the month of June, then the G-ADCCF 754 collects data locally at the application server 760 and receives collected data from the L-ADCCF 734. The collected data is amalgamated as illustrated in table 1, below, and reported back to the global data consumer 756.

TABLE 1
Example of data collected at G-ADCCF

| | | | | | | | | | |
|---|---|---|---|---|---|---|---|---|---|
| Date | Day | Start | End | Location | QFI | RTT | RTT deviation | PLMN/NPN ID | Slice ID |

| | | | | | | | | | | |
|---|---|---|---|---|---|---|---|---|---|---|
| June 12 | Monday | 1:12pm | 1:16pm | Cell A | 5QI-a | 123 | ms | 12.57 | ms | . . . |
| June 16 | Friday | 2:23pm | 2:27pm | Cell B | 5QI-b | 67 | ms | 9.88 | ms | . . . |
| June 20 | Tuesday | 10:02am | 10:33am | BSSID-1 | 5QI-c | 88.23 | ms | 10.52 | ms | . . . |
| June 20 | Tuesday | 10:13am | 10:24am | BSSID-2 | 5QI-d | 95.23 | ms | 11.63 | ms | . . . |

. . .

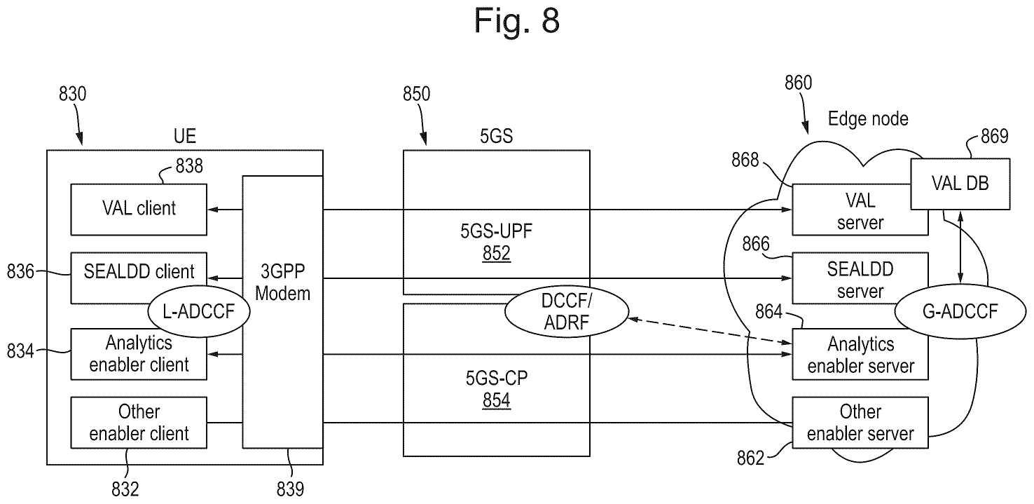

FIG. 8 illustrates the arrangement described herein implemented by a system 800 comprising entities within the 3GPP SA6 architecture. The system 800 comprises a UE 830 and an edge node 860. The UE 830 communicates with the edge node 860 via a 3GPP modem 839 and a 5G system 850. The UE 830 may comprise a wireless communications device 300 as described above, the edge node 860 may comprise a data collection node 500 as describe above.

A SEALDD layer (as defined in 3GPP TR 23.700-34, v 0.1.0) comprises a SEAL data delivery client 836 in the UE 830 and a SEAL data delivery server 866 in the edge node 860. The SEAL data delivery client 836 interacts with the SEAL data delivery server to establish an application layer data transport path via 5GS 850. SEALDD server 866 and SEALDD client 836 provide data transport service capabilities such as data plane packet processing (e.g., packet duplication, elimination, or transport coordination), data forwarding, data caching, background data transfer, etc. to support a VAL server 868 in the edge node 860 and a VAL client 838 in the UE 830.

In this example, an L-ADCCF is implemented by the SEALDD client 836. The G-ADCCF is implemented by the SEALDD server 866.

The edge node 860 further comprises an analytics enabler server 864 which performs the same function as ADAE-S described above. Further, the UE 830 comprises an analytics enabler client 834 which performs the same function as the ADAE-C described above.

In an alternative example the L-ADCCF is implemented by the analytics enabler client 834, and the G-ADCCF is implemented by the analytics enabler server 864.

A VAL layer is defined by a VAL client 838 in the UE 830 and a VAL server 868 in the edge node 860. The VAL layer is an application specific layer, for example a vertical application server and client, a gaming application server and client, or an edge application server and client. A VAL database 869 in the edge node 860 is the functional entity that contains information of the user profile associated with a VAL service that is served by the VAL service provider at the application plane.

The 5G system 850 is illustrated as comprising a 5GS user plane function 852 and a 5GS control plane 854. The 5G system additional comprises a DCCF and ADRF. The 5GS user plane function 852 connects the VAL layer and the SEALDD layer. The 5GS control plane 854 connects the analytics enablers 834, 864 and any other enablers 832, 862 provided.

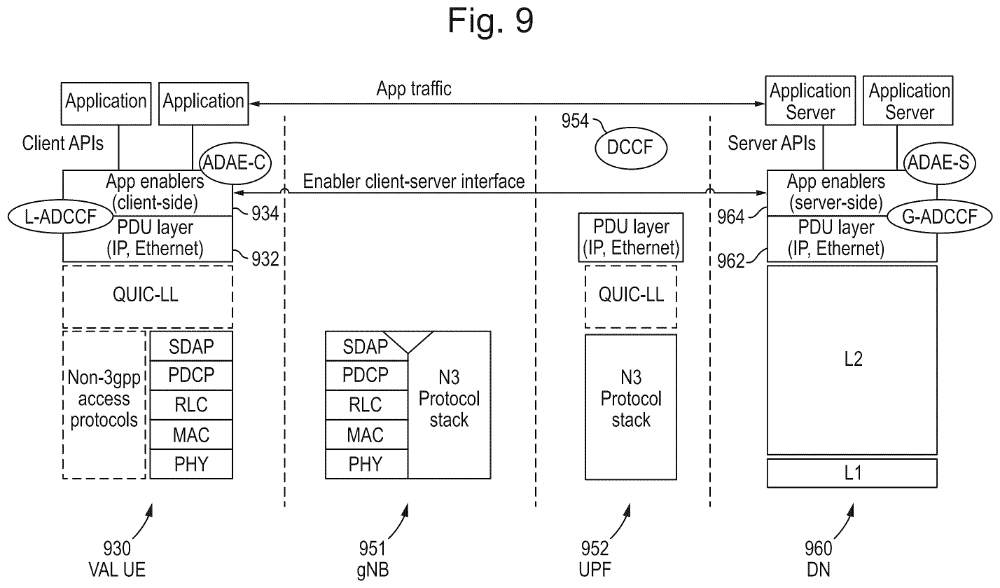

FIG. 9 illustrates how these entities are mapped to the user-plane protocol stack from UE to an edge node of the data network. The system 900 of FIG. 9 comprises a Vertical Application Layer UE 930, a gNB 951, a User Plane Function (UPF) 952 and an edge node 960 of a data network. The VAL UE 930 may comprise a wireless communications device 300. The edge node 960 may comprise a data collection node 500 as describe above. VAL UE 930 and gNB 951 communicate via a 5G 3GPP wireless communications network, the protocol stack for which is illustrated in each of Val UE 930 and gNB 951. VAL UE 930 comprises an L-ADCCF which may be implemented in either an application enabler client 934 or a PDU layer 932 of the UE 930. Similarly, a G-ADCCF may be implemented in either an application enabler server 964 or a PDU layer 962 of the edge node 960.

The application enabler server 964 may perform the same function as ADAE-S described above. Further, the application enabler client 934 may perform the same function as the ADAE-C described above.

A DCCF 954 is implemented in the UPF 952.

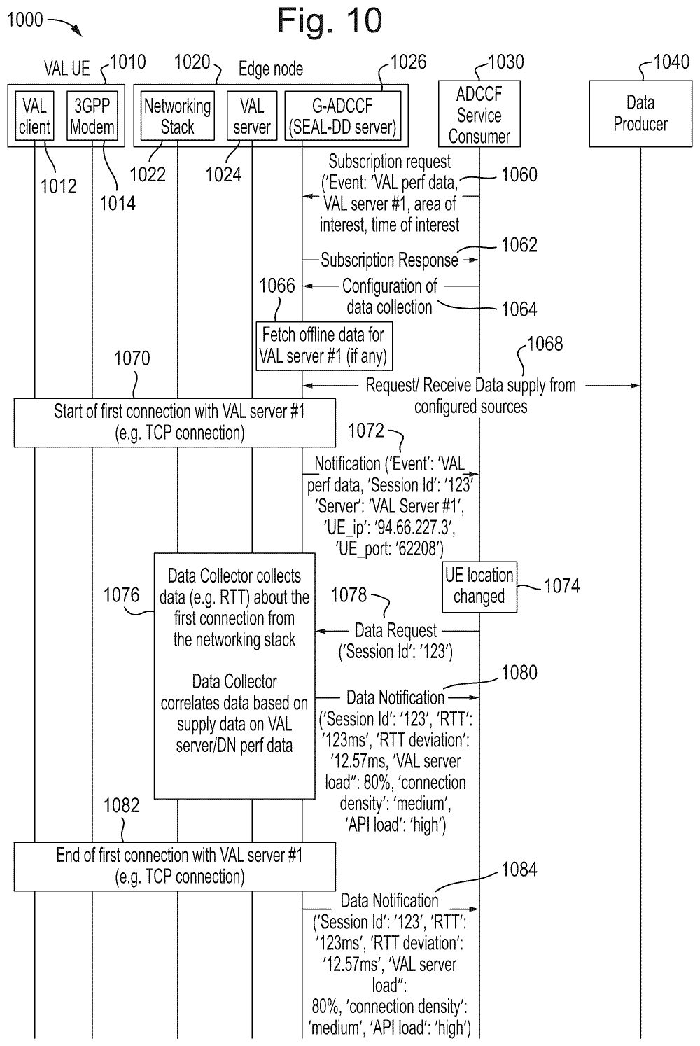

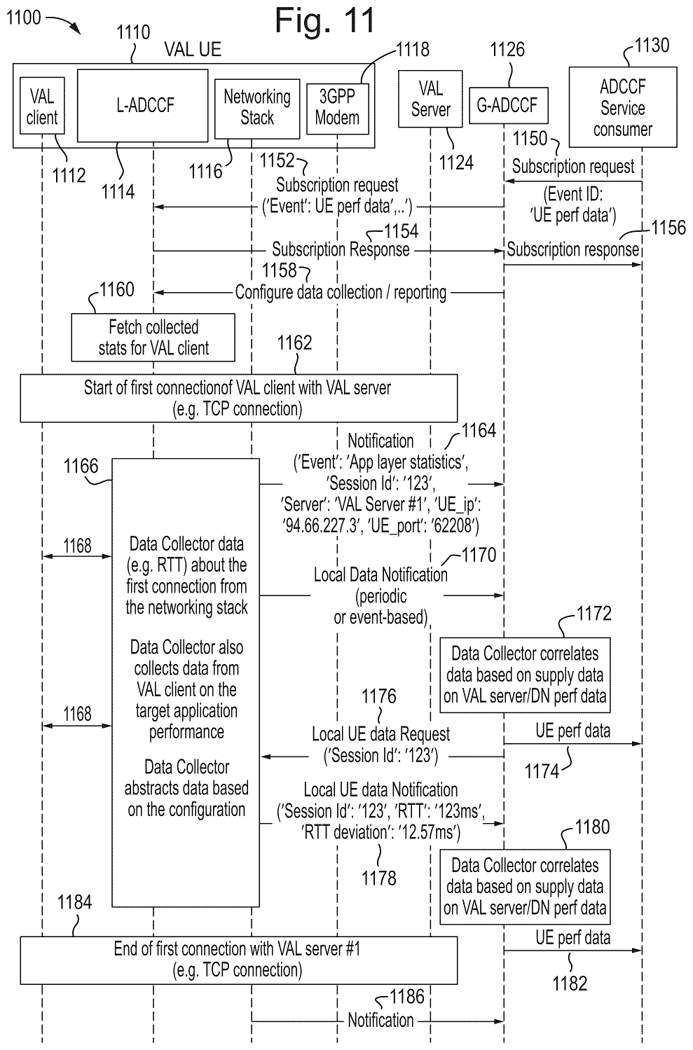

The operation of the above arrangements will now be described with reference to FIGS. 10 and 11.

FIG. 10 is a signaling diagram illustrating data collection for server performance prediction. FIG. 10 illustrates a system 1000 comprising a Vertical Application Layer (VAL) UE 1010, an edge node 1020, and ADCCF service consumer 1030 and a data producer 1040. The VAL UE 1010 may be a UE 300 as described above. The edge node 1020 may be a data collection node 500 as described above. The VAL UE 1010 comprises a VAL client 1012 and a 3GPP modem 1014. The VAL UE 1010 communicates with the edge node 1020 via a 3GPP wireless communications network. The edge node 1020 may comprise a cloud platform. The edge node 1020 comprises a networking stack 1022 for the 3GPP wireless communications network. The edge node 1020 further comprises at least one VAL server and a G-ADCCF 1026. The G-ADCCF may be implemented by way of a SEAL-DD server. The ADCCF service consumer is a requesting entity that requests performance data collection in the wireless communications network. The requesting entity 1030 may comprise an ADAE-S or a VAL server. Data producer 1040 is an example of a node that provides additional network performance data to the G-ADCCF. Data producer 1040 may comprise a VAL server, an Edge Application Server, a Network Function, a platform, or an Operation Administration and Management.

In overview, in the process shown in FIG. 10 starts with the G-ADCCF 1026 initially receiving a subscription request for data collection from a service consumer 1030 (e.g., ADAES, VAL server) which can be for a specific event identity and/or type (e.g. VAL performance data). At the same time as or subsequent to the subscription the service consumer 1030 may also configure the data collection required (e.g. which sources and what granularity of data, this may include a definition of the abstraction required). Based on the subscription, the ADCCF 1030 checks whether offline data about the VAL server 1024 data network performance exist and are accessible. Such offline data may be available from an ADRF. Then, the ADCCF 1030 also requests and receives data from the configured data sources (edge platform load data, 5GC monitoring data, SEAL data, PM/FM data from OAM). When a relevant session starts, which is a session between the VAL server 1024 and VAL UE 1010 via 5GS and identified by the event identity, then the G-ADCCF 1026 may also collect data from the networking stack 1022 (TCP/QUIC/UDP/IP) related to the performance of the end-to-end session. The ADCCF 1030 may abstract and/or correlate the data from real-time measurement from the networking stack with the data received before the session and will provide this data to the service consumer 1030 in the format requested by the service consumer 1030. The requested data may be provided periodically or based on the occurrence of an event identified by the event identity, such as a performance lower than a threshold, or based on the consumer request. For example, the provided data can be an indication of an RT deviation, a VAL server 1024 load at the target service area where the session is ongoing, a network status at the target area, or an active UE connection density.

The operation of the arrangement 1000 of FIG. 10 will now be descried in detail. Initially, the G-ADCCF 1026 is discovered and registered to the data producers 1040 and ADRF such that it is able to obtain offline and/or online data and/or measurements.

At 1060, the G-ADCCF 1026 service consumer (which can be an analytics enabler server, or a VAL server 1024, or an edge application server) subscribes to G-ADCCF 1026 with a data request that indicates a real-time performance data for VAL server 1024 (using a unique event identifier). This request includes the event identifier, the area of interest for which performance data is required and time of interest for which performance data is required as well as the identity of the application server or interest for which performance data is required.

At 1062, the G-ADCCF 1026 provides a response to the subscription request, indicating a positive or negative acknowledgement.

At 1064, the G-ADCCF 1026 service consumer, in response to receiving a positive ACK, may optionally send to G-ADCCF 1026 a configuration of the data collection requirement for the event type. Such configuration includes the data type and data producers 1040 required for the event identifier. The configuration may also include abstraction, granularity, and/or frequency of the required data collection. The configuration may also include criteria and/or thresholds for triggering a data notification. Alternatively, the configuration of the data collection requirement for the event type is performed at the G-ADCCF 1026.

At 1066, the G-ADCCF 1026 initially requests and receives offline data for the application server performance from a database. The G-ADCCF 1026 may use the mapping of the event identifier to data producers to determine where to direct the requests. The database may be the ADRF.

At 1068, the G-ADCCF 1026 may also receive additional data which could be useful for the derivation of the application server performance data. Sources of such additional data may be identified using the mapping of event identifier to data producers. Such additional data can be obtained from the following data producers.
Edge platform: Edge node load data, edge node available computational resources, edge processing average delay per transaction, failed/successful transactions, number of API invocations (which may allow for capture of possible delays at the edge segment).
Network Exposure Function monitoring events: Monitoring of network/slice load and conditions (which may allow for capture of events at a 5GC segment).
OAM performance data: performance management data from a Management System. This may provide average performance measurements for the network segment.
RAN Intelligent Controller (RIC) data related to RAN performance expectation, such as RAN load.
VAL server 1024 performance data: VAL server 1024 can provide via an API the service experience to the ADCCF 1030. Such service experience may be measured as throughput, packet error rate (PER), jitter, for example.

O-RAN is an alliance which investigates the virtualization of access domain and considers the virtualization of control functionalities (Self-Organizing Networks (SON) and/or Radio Resource Management (RRM)) to a newly defined RAN Intelligent Controller (RIC) which may be co-located with the gNB or can be deployed for a cluster of gNBs or can be deployed at an edge node. A RIC consists two different entities: a non-Real Time (RT) RIC, and a near-RT RIC. The non-RT RIC comprises a logical function that enables non-real-time control and optimization of RAN elements and resources, artificial intelligence/machine learning workflow including model training and updates, and policy-based guidance of applications/features in Near-RT RIC. The near-RT RIC comprises a logical function that enables near-real-time control and optimization of RAN elements and resources via fine-grained (e.g. UE basis, Cell basis) data collection and actions over E2 interface. A RIC as a service producer may provide to the data collection coordination function data or analytics related to the RAN performance for the set of cells within the application server service area. Such performance data or analytics can relate for example to the radio bearer conditions, the radio channel performance, the RAN slice performance, UE-related RAN performance, cell switching and/or traffic steering events for one or more UEs, RRM/SON outputs.

At 1070 a first connection to the VAL server 1024 from the VAL UE 1010 starts. This connection is identified by an event matching the event identifier of the data request.

At 1072 a notification is sent from the G-ADCCF 1026 to the data consumer 1030 to indicate that real-time performance data can be provided for an ongoing session. This session can be any session within the area of interest, or if the event is for a target LE, the session is between the target UE 1010 and VAL server 1024.

At 1076 the G-ADCCF 1026 starts collecting data from the networking stack for the ongoing session. The G-ADCCF 1026 also performs any required processing such as correlations or abstractions on the previously collected data collected at 1066 and 1068. For example, the RTT deviation may be monitored from the networking stack 1022, and the RTT together with the per segment performance data as obtained in steps 1066 and 1068 (e.g. edge, application server, 5GC, RAN/TN (from OAM averaged)) will help providing the real-time performance measurement and the decomposition to different segments (e.g. RTT deviation is Xms, edge delay is Yms, VAL server #1 1024 load is 80%, RAN/network delay is Zms).

At 1078, the G-ADCCF 1026 may get a request from the data consumer 130 to obtain data while the session is running (or the G-ADCCF 1026 may be configured to provide the data notification periodically or based on a monitoring event). The G-ADCCF 1026 or the data consumer 130 may also detect a trigger event e.g. UE mobility 1074 towards an area covered by different VAL server 1024.

It should be noted that in the alternative case where the G-ADCCF 1026 detects a reporting event then step 1078 is not needed. In that case, the G-ADCCF 1026 monitors the data source (i.e. VAL server 1024) serving the UE 1010. If the UE 1010 changes source the G-ADCCF 1026 will re-subscribe to a second VAL server, VAL server #2.

At 1080, the G-ADCCF 1026 sends a data notification to the data consumer 1030 which includes the data collected and processed as in step 1076.

At 1082 the connection of the UE 1010 to the VAL server #1 1024 finishes.

At 1084, the G-ADCCF 1026 sends a notification to the data consumer 1030 informing it of the termination of the real-time session. In case of migration of the UE session to VAL server #2, the G-ADCCF 1026 indicates the change of VAL server 1024 and (if the data consumer 1024 wants to continue getting data in respect of the new server), the G-ADCCF 1026 starts subscribing to VAL server #2 as data producer and starts collecting data for VAL server #2.

FIG. 11 is a signaling diagram illustrating data collection for application session performance prediction. FIG. 11 illustrates a system 1100 comprising a Vertical Application Layer (VAL) UE 1110, a VAL server 1124, a G-ADCCF 1126, and an ADCCF service consumer 1130. The VAL UE 1110 may be a LE 300 as described above. The VAL server 1124 may comprise a data collection node 500 as described above. The VAL UE 1110 comprises a VAL client 1112, an L-ADCCF 1114, a networking stack 1116 and a 3GPP modem 1118. The VAL UE 1110 communicates with the VAL server 1124 via a 3GPP wireless communications network. The ADCCF service consumer 1130 is a requesting entity that requests performance data collection in the wireless communications network. The service consumer 1130 may comprise an ADAES, a VAL server or even a VAL client at the UE 1112.

In overview, in the process shown in FIG. 11 the L-ADCCF 1114 is deployed at the VAL UE 1110. The L-ADCCF 1114 is implemented as a software module running on a processor of the VAL UE 1110. The L-ADCCF 1114 initially receives a subscription request for data collection from the G-ADCCF 1126 with an event identity. The subscription request is a request for network performance data, and it originates from the service consumer 1130. The subscription request comprises an event identity, and specifies the network performance data required. The event identity indicates the event or session of interest and for which performance data is required. The network performance data required may indicate the network performance metrics that are to be measured for the identified event. Together with the subscription request, or subsequently, the data consumer 1130 may also configure the data collection required. The configuration of data collection may include which sources to collect data from and at what granularity to collect data. The granularity may indicate a measurement interval.

The subscription request may indicate historical data to be collected and data to be collected from nodes other than the VAL UE 1110, as described above at steps 1066 and 1068. Based on the subscription, the G-ADCCF 1126 checks whether offline local UE data exist/are accessible about the VAL UE/session performance. When a session starts between the VAL server 1124 and the VAL UE 1110, the session as identified by the event identity included in the subscription request, then the L-ADCCF 1114 collects local data from the networking stack 1116 (TCP/QUIC/UDP/IP) related to the performance of the session. The L-ADCCF 1114 sends the collected data to the G-ADCCF 1126. The G-ADCCF 1126 receives this collected data and may process the collected data. The processing of the collected data may comprise abstracting and/or correlating the collected data. The collected data may comprise real-time local UE measurements from the networking stack combined with the data received before the session. The processed data is sent to the service consumer 1130. The processed data can be provided to the service consumer 1130 periodically, or in response to the occurrence of an event. The event may comprise a performance metric dropping below a threshold or may comprise a subscription request from the consumer that indicates immediate response is required.

The detailed operation of the arrangement of FIG. 11 will now be described. It is noted that the G-ADCCF 1126 is discovered by and registered to the service consumers 1130 and the ADRF (not shown) such that it can obtain offline and online data. Further, the L-ADCCF 1114 of the VAL UE 1110 is connected to G-ADCCF 1126.

At 1150 the ADCCF service consumer 1130 sends a subscription request to the G-ADCCF 1126 requesting real-time network performance data for VAL UE 1110. This request includes the event identity, the area of interest and the time of interest as well as the identity of the application and the UE 1110. The ADCCF service consumer 1130 can be an analytics enabler server, or a VAL server, or an edge application server. In an alternative arrangement the VAL client 1112 can operate a service consumer 1130, that option is not illustrated in FIG. 11 for clarity.

At 1152, the G-ADCCF 1126, in response to receiving the subscription request in 1150, sends a data collection request to L-ADCCF 1114 in VAL UE 1110. This data collection request indicates the event identity and the local data collection requirement.

At 1154, the L-ADCCF 1114 provides a response to the data collection request of the G-ADCCF 1126, the response indicating a positive acknowledgement.

At 1156, the G-ADCCF 1126 provides a response to the subscription request of the consumer, indicating a positive acknowledgement.

At 1158 the G-ADCCF 1126, in response of receiving a positive acknowledgement, sends to L-ADCCF 1114 a configuration of the data collection requirement for the identified event type. The configuration may include any of: the data type required for the event identity, the granularity and/or frequency of the data collection, any processing or abstraction of the collected data, the granularity and/or frequency of the data reporting, any criteria for reporting such as thresholds that triggering a data notification to be sent. In an alternative embodiment the G-ADCCF 1126 forwards the subscription request to the L-ADCCF 1114 and the mapping of the event identity to data required is performed by the L-ADCCF 1114 instead of the G-ADCCF 1126.

At 1160, the G-ADCCF 1126 fetches local UE offline data from a local memory at the VAL UE 1110. The local memory may be provided by an application entity at the VAL 1110. The local UE offline data required is identified using the event identity received in the data collection request.

At 1162, a first connection of the VAL server 1124 to the VAL UE 1110 is stablished, the established connection matching the event identity.

At 1164, a notification is sent from the L-ADCCF 1114 to the G-ADCCF 1126 and in turn to the service consumer 1130 to indicate that real-time UE performance data can be provided for an ongoing session.

At 1166, the L-ADCCF 1114 starts collecting data from the networking stack 1116 for the ongoing session.

At 1168, the L-ADCCF 1114 requests and receives data from the VAL client 1112 at the VAL UE 1110 on the session performance. Session performance metrics may include packet error rate, jitter, and/or throughput. Optionally, the L-ADCCF 1114 may then process the collected data.

At 1170, the L-ADCCF 1114 sends the collected data as a notification to the G-ADCCF 1126. If the L-ADCCF 1114 processes the collected data, then the L-ADCCF 1114 sends this processed data to the G-ADCCF 1126.

At 1172, the G-ADCCF 1126 processes the received data and optionally combines the data received from the L-ADCCF 1114 with data from other data sources. The processing may comprise correlation and/or combination with data from other data sources. Data from other sources may be received at G-ADCCF 1126 as described in relation to steps 1066 and 1068 in connection with FIG. 10. Then, at 1174 the G-ADCCF 1126 provides the processed collected data to the service consumer 1130.

At 1176, the L-ADCCF 1114 receives a request from the G-ADCCF 1126 to send data while the session is running. Alternatively, the L-ADCCF 1114 may have already been instructed to provide collected data periodically or based on a monitoring event. The G-ADCCF 1126 or the service consumer 1130 may also detect a trigger event, such as the VAL UE 1110 moving into an area covered by the VAL server 1124, and it then requests additional data for the UE session.

At 1178 the L-ADCCF 1114 sends the requested additional local UE data as notification to the G-ADCCF 1126. At 1180 the G-ADCCF 1126 processes the received collected data and provides this to the service consumer 1130.

At 1184, the connection of the VAL UE 1110 to the VAL server 1124 finishes.

At 1186, the L-ADCCF 1114 sends a notification to the G-ADCCF 1126 to inform it of the termination of the real-time session.

It should be noted that the above-mentioned methods and apparatus illustrate rather than limit the invention, and that those skilled in the art will be able to design many alternative arrangements without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

Further, while examples have been given in the context of particular communications standards, these examples are not intended to be the limit of the communications standards to which the disclosed method and apparatus may be applied. For example, while specific examples have been given in the context of 3GPP, the principles disclosed herein can also be applied to another wireless communications system, and indeed any communications system which uses routing rules.

The method may also be embodied in a set of instructions, stored on a computer readable medium, which when loaded into a computer processor, Digital Signal Processor (DSP) or similar, causes the processor to carry out the hereinbefore described methods.

The described methods and apparatus may be practiced in other specific forms. The described methods and apparatus are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method performed by a wireless communications device, the method comprising:
receiving a data collection requirement from a data collection coordination node, the data collection requirement defining a data collection event associated with application traffic between the wireless communications device and a node within a wireless communications network;
detecting an occurrence of the data collection event;
collecting data associated with the application traffic between the wireless communications device and the node within the wireless communications network with respect to the data collection event; and
sending the collected data to the data collection coordination node.

2. The method of claim 1 further comprising processing the collected data before sending the collected data to the data collection coordination node.

3. The method of claim 1, wherein the data collection requirement includes at least one of:
parameters to be collected for the data collection event;
a resolution at which the data is to be collected;
an event identity identifying the data collection event;
a time validity;
a geographical area;
an application service area;
an application identity; or
conditions for triggering the data collection event.

4. The method of claim 1, wherein the data collection event comprises at least one of:
an end-to-end application performance related event for the application traffic associated with the wireless communications device;
the end-to-end application performance related event for the application traffic associated with the wireless communications device and an application server;
the end-to-end application performance related event for the application traffic associated with the wireless communications device and one or more additional wireless communications devices;
an application server performance related event; or
a change of application traffic parameters.

5. The method of claim 1, wherein detecting the occurrence of the data collection event comprises at least one of:
initiation of a communication related to the application traffic;
a modification of one or more performance parameters related to the application traffic;
a modification or a termination of the communication related to the application traffic; or
a deviation of a performance parameter from a desirable key performance indicator related to the application traffic.

6. A wireless communications device comprising:
at least one memory; and
at least one processor coupled with the at least one memory and configured to cause the wireless communications device to:
receive a data collection requirement from a data collection coordination node, the data collection requirement defining a data collection event associated with application traffic between the wireless communications device and a node within a wireless communications network;
detect an occurrence of the data collection event;
collect data associated with the application traffic between the wireless communications device and the node within the wireless communications network with respect to the data collection event; and
send the collected data to the data collection coordination node.

7. A data collection coordination node, comprising:
at least one memory; and
at least one processor coupled with the at least one memory and configured to cause the data collection coordination node to:
transmit a first data collection requirement to a wireless communications device, the first data collection requirement defining a first data collection event associated with application traffic between the wireless communications device and a node within wireless communications network; and
receive collected data associated with the application traffic between the wireless communications device and the node within the wireless communications network with respect to the first data collection event.

8. The data collection coordination node of claim 7, wherein the at least one processor is configured to cause the data collection coordination node to:
transmit a second data collection requirement to an edge node, the second data collection requirement defining a second data collection event associated with an operation of the edge node; and
receive collected data associated with the second data collection requirement.

9. The data collection coordination node of claim 8, wherein one or more of the first data collection event or the second data collection event comprises at least one of:
parameters to be collected;
a resolution at which data is to be collected;
an event identity;
a time validity;
a geographical area;
an application service area;
an application identity; or
conditions for triggering the first data collection event or the second data collection event.

10. The data collection coordination node of claim 8 wherein one or more of the first data collection event or the second data collection event comprises at least one of:
an end-to-end application performance related event for the application traffic;
the end-to-end application performance related event for the application traffic associated with the wireless communications device and one or more additional wireless communications devices;
an edge data network performance related event;
a radio access network performance related event;
a wireless communication device location event;
an application server performance related event; or
an application traffic parameters change event.

11. The data collection coordination node of claim 7, wherein the at least one processor is configured to cause the data collection coordination node to store the received collected data.

12. The data collection coordination node of claim 7, wherein the at least one processor is configured to cause the data collection coordination node to generate a set of processed data based on the received collected data.

13. The data collection coordination node of claim 12, wherein the at least one processor is configured to cause the data collection coordination node to store the set of processed data.

14. The data collection coordination node of claim 13, wherein the at least one processor is configured to cause the data collection coordination node to transmit the set of processed data to an external entity.

15. (canceled)

16. The wireless communications device of claim 6, wherein the at least one processor is configured to cause the wireless communications device to process the collected data before sending the collected data to the data collection coordination node.

17. The wireless communications device of claim 6, wherein the data collection requirement includes at least one of:
parameters to be collected for the data collection event;
a resolution at which the data is to be collected;
an event identity identifying the data collection event;
a time validity;
a geographical area;
an application service area;
an application identity; or
conditions for triggering the data collection event.

18. The wireless communications device of claim 6, wherein the data collection event comprises at least one of:
an end-to-end application performance related event for the application traffic associated with the wireless communications device;
the end-to-end application performance related event for the application traffic associated with the wireless communications device and an application server;
the end-to-end application performance related event for the application traffic associated with the wireless communications device and one or more additional wireless communications devices;
an application server performance related event; or
a change of application traffic parameters.

19. The wireless communications device of claim 6, wherein detection of the data collection event comprises at least one of:
initiation of a communication related to the application traffic;
a modification of one or more performance parameters related to the application traffic;
a modification or a termination of a communication related to the application traffic; or
a deviation of a performance parameter from a desirable key performance indicator related to the application traffic.

20. A processor for wireless communication, comprising:
at least one controller coupled with at least one memory and configured to cause the processor to:
receive a data collection requirement from a data collection coordination node, the data collection requirement defining a data collection event associated with application traffic between a wireless communications device and a node within a wireless communications network;
detect an occurrence of the data collection event;
collect data associated with the application traffic between the wireless communications device and the node within the wireless communications network with respect to the data collection event; and
send the collected data to the data collection coordination node.

21. The processor of claim 20, wherein the at least one controller is configured to cause the processor to process the collected data before sending the collected data to the data collection coordination node.
